(19) United States
(12) Patent Application Publication
(10) Pub. No.: US 2023/0367583 A1
(43) Pub. Date: Nov. 16, 2023

(54) UPDATE MANAGEMENT SYSTEM AND UPDATE MANAGEMENT METHOD

(71) Applicant: Mitsubishi Electric Corporation, Tokyo (JP)

(72) Inventors: Tsubasa MORITA, Tokyo (JP); Takuya KONO, Tokyo (JP)

(73) Assignee: Mitsubishi Electric Corporation, Tokyo (JP)

(21) Appl. No.: 18/303,907

(22) Filed: Apr. 20, 2023

(30) Foreign Application Priority Data
May 16, 2022 (JP) 2022-080002

(51) Int. Cl. G06F 8/65

(52) U.S. Cl. CPC G06F 8/65

(57) ABSTRACT

Whether or not the state of update failure on the vehicle side matches the SW versions in any of existing vehicle versions on the OTA server side is searched, and when there is a match, rollback is not executed and the matched vehicle version is maintained. Accordingly, in the next OTA update, the size of difference data corresponding to the difference between the SW versions of old programs and the SW versions of new programs can be reduced when compared with that when rollback is executed. Therefore, the time required for the OTA update process can be reduced.

### BACKGROUND OF THE INVENTION

### 1. Field of the Invention

The present disclosure relates to an update management system and an update management method.

### 2. Description of the Background Art

Among services and functions provided by a vehicle, some are realized not by a single Electronic Control Unit (ECU) but by a plurality of ECUs. For example, an Advanced Driving Assistant System (ADAS) function is realized through control by a driving control ECU, a front camera, and sensors. When the ADAS function is added, corrected, or deleted by using an Over The Air (OTA) update function, the software versions (hereinafter, SW versions) of ECUs related to the ADAS function need to be updated with a correct combination, of SW versions registered in an OTA server, that realizes the ADAS function. Thus, there is a known technology as below. That is, in a case where software of an on-vehicle ECU is to be updated by an OTA update function, even when a part of the update process is suspended, the amount of update data having been written until the occurrence of the suspension is stored, and when a rewriting process of the program is resumed, a vehicle master device is requested to transmit remaining update data in accordance with the stored amount of the update data having been written (see Patent Document 1, for example).
Patent Document 1: Japanese Laid-Open Patent Publication No. 2020-27635

However, at the time of OTA update, if even a single one of a plurality of ECUs has failed in update of the SW version thereof due to abnormality of the system or the like, a correct combination of SW versions that realizes the ADAS function is not obtained, whereby the ADAS function is not realized. Therefore, conventionally, a process (rollback) of restoring all the SW versions to the states before the update is performed, whereby operation of the vehicle is guaranteed and safety is ensured. Thus, even when the state of the SW versions at the time of the update failure is not the newest versions on the server side but is newer than the versions before the update and matches an existing vehicle version, rollback is executed. Therefore, when update to the newest SW versions is performed, all of the update process needs to be executed from the beginning, which poses a problem that the update process requires a long time.

### SUMMARY OF THE INVENTION

The present disclosure has been made in order to solve the above-described problem. An object of the present disclosure is to provide an update management system and an update management method that can reduce the time required for an OTA update process at the time of update failure.

An update management system according to the present disclosure includes: a software update management device for managing update of software of a plurality of update target devices installed in a vehicle; and a server provided outside the vehicle and being for managing, in time series, a set of update software versions of the plurality of update target devices, as a vehicle version. When update of software of at least one update target device out of the plurality of update target devices is not able to be performed, information of software versions of the plurality of update target devices at a time point when the update is not able to be performed is transmitted to the server, and when there is a vehicle version that matches a set of the transmitted software versions, the software update management device withholds a process of restoring the software versions of the plurality of update target devices to a state before the update.

In an update management method according to the present disclosure, when update of software of at least one update target device out of a plurality of update target devices installed in a vehicle is not able to be performed, and software versions of the plurality of update target devices at a time point when the update is not able to be performed match one of vehicle versions being a set of update software versions managed in time series, a process of restoring the software versions of the plurality of update target devices to a state before the update is withheld.

According to the update management system and the update management method according to the present disclosure, the time required for an OTA update process at the time of update failure can be reduced.

### BRIEF DESCRIPTION OF THE DRAWINGS

FIG. 1 is a conceptual diagram describing the concept of update management in an update management system according to a first embodiment;

FIG. 2 is a function block diagram of the update management system according to the first embodiment;

FIG. 3 is another function block diagram of the update management system according to the first embodiment;

FIG. 4 is a flowchart describing operation according to the first embodiment; and

FIG. 5 shows an example of hardware configuration of a vehicle state management device, an SW update management device, and an SW update information display device.

### DETAILED DESCRIPTION OF THE PREFERRED EMBODIMENTS OF THE INVENTION

Hereinafter, a preferred embodiment of an update management system according to the present disclosure will be described with reference to the drawings. The same components and corresponding parts are denoted by the same reference characters, and detailed descriptions thereof will be omitted.

### First Embodiment

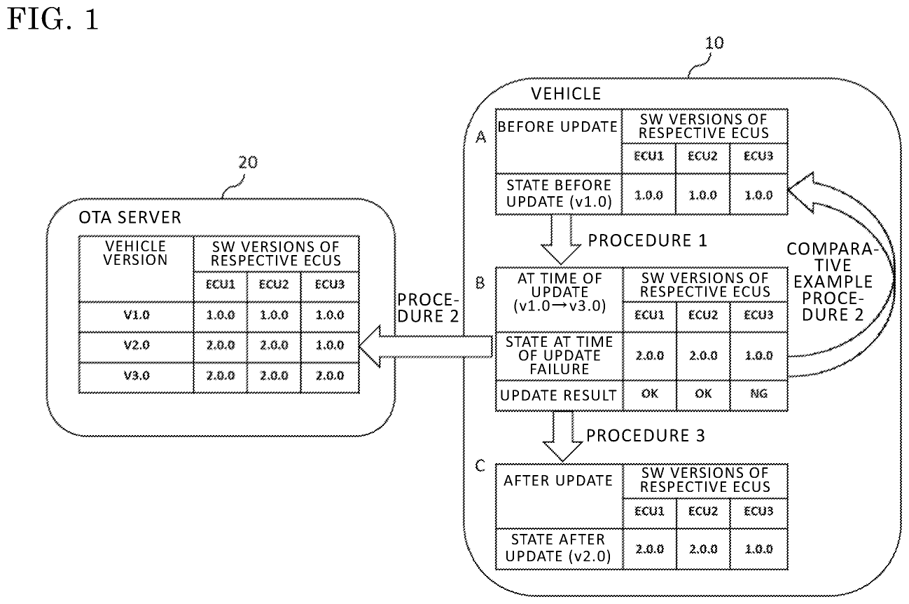

FIG. 1 is a conceptual diagram describing the concept of update management in an update management system of the present embodiment, in comparison with a comparative example.

In A of FIG. 1, it is assumed that the vehicle version of a vehicle 10 is v1.0, the software version (hereinafter, SW version) of an ECU 1 is 1.0.0, the SW version of an ECU 2 is 1.0.0, and the SW version of an ECU 3 is 1.0.0. The vehicle version is newer from v1.0 toward v3.0, and as for the SW version as well, 2.0.0 is newer than 1.0.0. Here, the vehicle version shows, in time series, a set of pieces of update software of a plurality of ECUs installed in the vehicle.

The SW versions of the ECUs 1 to 3 of the vehicle are to be updated such that the vehicle version is updated from v1.0 to v3.0 (procedure 1 in FIG. 1). However, it is assumed that: since system abnormality has occurred during update work according to procedure 1, update has been performed up to the state in B of FIG. 1, i.e., the SW version of the ECU 1 is 2.0.0, the SW version of the ECU 2 is 2.0.0, and the SW version of the ECU 3 is 1.0.0; and the update is suspended.

In this case, as described above, in a case were OTA update of a plurality of ECUs is to be performed, unless all of the update target ECUs have been updated, the function is not realized. Therefore, in accordance with procedure 2 of the comparative example, the update work is rolled back to A of FIG. 1 being the state before the update. However, in an update management device of the present embodiment, in procedure 2, the SW versions of the respective ECUs at the time of update failure are compared with the SW versions of the respective ECUs managed in an OTA server 20, and when the set of the SW versions at the time of update suspension matches a set of SW versions in any of the vehicle versions (in this description, matches a vehicle version v2.0), this is maintained and rollback is not performed (withheld) (procedure 3 in FIG. 1).

In this manner, whether or not the state of update failure on the vehicle side matches the SW versions in any of the existing vehicle versions on the OTA server side is searched, and when there is a match, rollback is not executed and the matched vehicle version is maintained. Accordingly, in the next OTA update, the size of difference data corresponding to the difference between the SW versions of old programs and the SW versions of new programs can be reduced when compared with that when rollback is executed. Therefore, the time required for the OTA update process can be reduced.

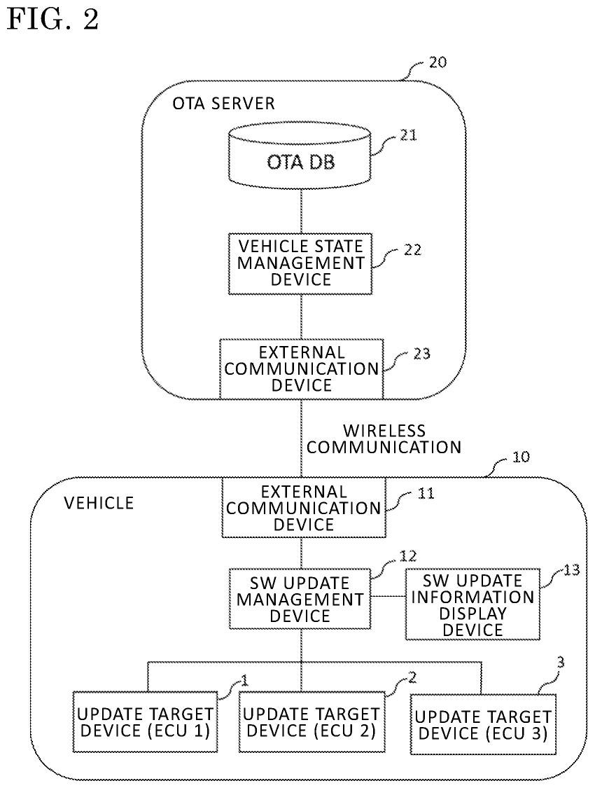

An example of the configuration of such an update management system will be described in detail with reference to a function block diagram in FIG. 2. In FIG. 2, the vehicle 10 is connected to the OTA server 20 through wireless communication, and downloads update data corresponding to the configurations of the hardware (HW) and the software (SW) of the vehicle 10 from the OTA server 20.

The vehicle 10 includes: an external communication device 11 for performing wireless communication such as mobile communication with the OTA server 20; an SW update management device 12 having a function regarding a software update process according to OTA; an SW update information display device 13 for displaying update information according to OTA; and update target devices 1 to 3 of which software is to be updated with update data. Here, description will be given assuming that the update target devices 1 to 3 are the ECUs 1 to 3.

Results of rewriting of the software of the target ECUs 1 to 3 by the software update process are returned to the OTA server 20, whereby the status of software update according to OTA of each vehicle is collectively managed by the OTA server 20.

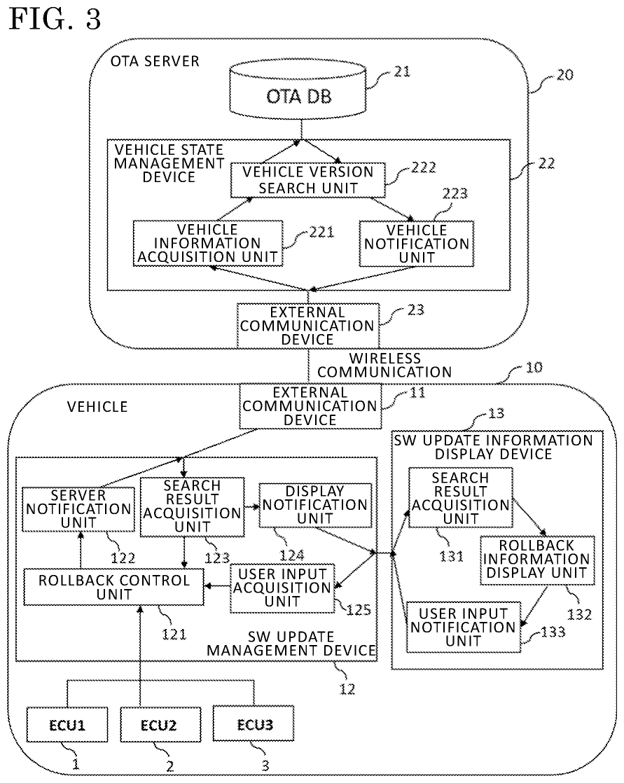

Next, a vehicle state management device 22, the SW update management device 12, and the SW update information display device 13, which are characteristic functions of the present embodiment, will each be described with reference to FIG. 3.

<SW update management device 12>

The SW update management device 12 has a rollback control unit 121, a server notification unit 122, a search result acquisition unit 123, a display notification unit 124, and a user input acquisition unit 125.

(1) The rollback control unit 121, in a state where even a single one of the ECUs 1 to 3 has failed in software update due to system abnormality or the like in the SW update management device 12, withholds execution of rollback and acquires update result information of the SW versions of the respective ECUs 1 to 3 at the time of the update failure. When the update result of the SW versions of the respective ECUs 1 to 3 at the time of the update failure does not match the SW versions of the respective ECUs in any of the vehicle versions in the OTA server, the rollback control unit 121 executes rollback. When there is a match in the search result of the SW versions in the vehicle versions, the rollback control unit 121 performs control corresponding to either “execute rollback” or “do not execute rollback”, in accordance with a user input.

(2) The server notification unit 122 notifies the OTA server 20 of information (i) and (ii) below from the vehicle 10 via the external communication devices 11, 23.
(i) the SW versions of the respective ECUs 1 to 3 at the time of the update failure.
(ii) the result of either “execute rollback” or “do not execute rollback”.

(3) The search result acquisition unit 123 acquires information (iii) and (iv) below from the OTA server 20 to the vehicle 10 via the external communication devices 23, 11.
(iii) the search result regarding a match or a mismatch with the SW versions of the respective ECUs in the vehicle versions.
(iv) when there is a match, the matched vehicle version and update contents of the SW versions in the vehicle version.

(4) The display notification unit 124 notifies the SW update information display device 13 of information below.
(v) the vehicle version when there is a match with the SW versions of the respective ECUs in a vehicle version, and update contents of the SW versions in the vehicle version.

(5) The user input acquisition unit 125 acquires information below from the SW update information display device 13.
(vi) a user selection result regarding execution or non-execution of rollback.

<Vehicle State Management Device 22>

The vehicle state management device 22 has a vehicle information acquisition unit 221, a vehicle version search unit 222, and a vehicle notification unit 223.

(1) The vehicle information acquisition unit 221 acquires information below from the vehicle 10 via the external communication devices 11, 23.
(i) the SW versions of the respective ECUs 1 to 3 at the time of the update failure.
(ii) the result of either “execute rollback” or “do not execute rollback”.

(2) The vehicle version search unit 222 searches whether or not there is a match between the SW versions of the respective ECUs 1 to 3 at the time of the update failure and the SW versions of the respective ECUs in any of the vehicle versions of the OTA target vehicle registered in an OTA database 21 (hereinafter, OTA DB 21) of the OTA server 20. It should be noted that when the SW versions of the respective ECUs at the time of the update failure is the same as the SW versions in the vehicle version before the update, it is not considered that “there is a match” here.

(3) The vehicle notification unit 223 makes a notification of information below from the OTA server 20 to the vehicle 10 via the external communication devices 23, 11.
(i) the search result regarding a match or a mismatch with the SW versions of the respective ECUs in the vehicle versions.
(ii) when there is a match with the SW versions of the respective ECUs in a vehicle version, the matched vehicle version and update contents of the SW versions in the vehicle version.

<SW Update Information Display Device 13>

The SW update information display device 13 has a search result acquisition unit 131, a rollback information display unit 132, and a user input notification unit 133.

(1) The search result acquisition unit 131 acquires information below from the SW update management device 12.
(i) when there is a match with the SW versions of the respective ECUs in a vehicle version, the matched vehicle version and update contents of the SW versions in the vehicle version.

(2) The rollback information display unit 132 displays the matched vehicle version and the update contents of the SW versions in the vehicle version to the user. In addition, the rollback information display unit 132 displays “execute rollback, or do not execute rollback”, and receives, as a user input, a selection result of either “execute rollback” or “do not execute rollback” selected by the user.

(3) The user input notification unit 133 notifies the SW update management device 12 of information below.
(i) the user selection result of either “execute rollback” or “do not execute rollback”.

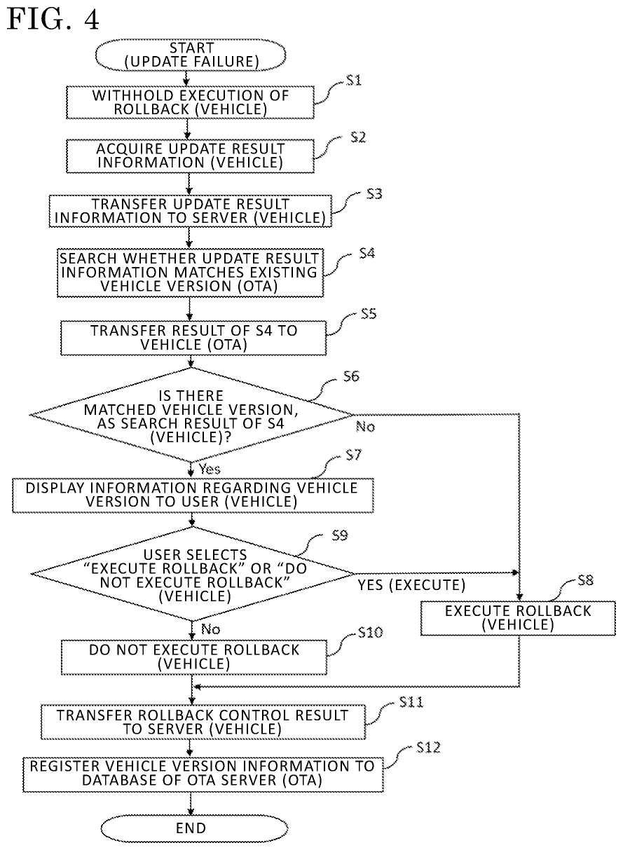

FIG. 4 is a flowchart describing operation of the update management system. This operation is performed by the SW update management device 12, the vehicle state management device 22, and the SW update information display device 13 executing predetermined programs. In the drawing, indication of vehicle or OTA in parentheses represents which of the vehicle 10 or the OTA server 20 the step is executed in.

When update has been suspended due to system abnormality, it is determined that an update failure has occurred, and the rollback control unit 121 withholds execution of rollback after the SW update failure (step S1). Then, the rollback control unit 121 acquires update result information of the SW versions of the respective ECUs 1 to 3 at the time of the update failure (hereinafter, update result information) (step S2), and transmits the update result information to the server notification unit 122.

The server notification unit 122 transfers the update result information to the OTA server 20 via the external communication devices 11, 23 (step S3).

The vehicle version search unit 222 searches whether the SW versions, in an existing vehicle version, that match the update result information transferred to the OTA server 20 are included in the OTA DB 21 (step S4).

The search result by the vehicle version search unit 222 is transferred to the vehicle 10 via the vehicle notification unit 223 and the external communication devices 23, 11 (step S5).

As the search result by the vehicle version search unit 222, when an existing vehicle version that has the SW versions that match the update result information is included in the OTA DB 21 (step S6), this information is inputted from the vehicle notification unit 223 to the search result acquisition unit 123 via the external communication devices 23, 11. Information inputted from the search result acquisition unit 123 to the display notification unit 124 is transmitted to the search result acquisition unit 131 of the SW update information display device 13, and the rollback information display unit 132 displays, to the user, the vehicle version and information regarding the update contents of the SW versions in the vehicle version (step S7). Then, selection by the user as to whether or not to allow execution of rollback is received as a user input (step S9).

When there is no existing vehicle version that has the SW versions that match the update result information, information is inputted from the search result acquisition unit 123 to the rollback control unit 121, to execute rollback (step S8). Meanwhile, when the user wishes execution of rollback, an input indicating execution is transmitted from the user input notification unit 133 to the rollback control unit 121 via the user input acquisition unit 125, and the rollback control unit 121 executes rollback (step S8).

When the user does not wish rollback, an input indicating no-execution is transmitted from the user input notification unit 133 to the user input acquisition unit 125, and based on this, the rollback control unit 121 does not execute rollback (step S10).

A rollback control result is transferred to the OTA server (step S11). When rollback has not been executed, a result indicating that rollback has not been executed, and the matched vehicle version as the search result, are registered in the OTA DB 21.

When rollback has been executed, the result of the execution and the updated vehicle version information are registered in the OTA DB 21 (step S12). It should be noted that whether or not to execute rollback may be determined only by the vehicle, without using a user operation.

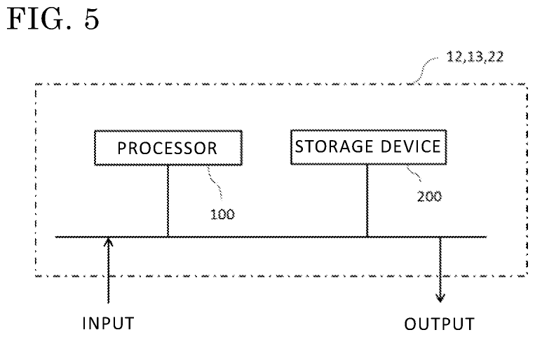

FIG. 5 shows an example of hardware of the SW update management device 12, the SW update information display device 13, and the vehicle state management device 22. The hardware is composed of a processor 100 and a storage device 200. Although not shown, the storage device includes a volatile storage device such as a random access memory, and a nonvolatile auxiliary storage device such as a flash memory. Instead of a flash memory, an auxiliary storage device of a hard disk may be provided. The processor 100 executes a program inputted from the storage device 200, thereby performing operation according to the flowchart in FIG. 4. In this case, the program is inputted to the processor 100 from the auxiliary storage device via the volatile storage device. The processor 100 may output data such as a calculation result to the volatile storage device of the storage device 200, or may store data into the auxiliary storage device via the volatile storage device.

As described above, according to the SW update management device 12, whether or not the state of the update failure on the vehicle side matches the SW versions in any of the existing vehicle versions on the OTA server side is searched, and when there is a match, rollback is not executed and the matched vehicle version can be maintained. In addition, since the SW update information display device 13 notifies the user whether or not execution of rollback is possible, whether or not to allow execution of rollback can be selected in accordance with needs of the user or the circumstances. Further, in the vehicle state management device 22, it is possible to search a vehicle version on the basis of which determination as to whether or not to allow execution of rollback is made. When these devices are used in combination, the time required in the OTA update process can be reduced in accordance with the circumstances and needs.

Although the disclosure is described above in terms of an exemplary embodiment, it should be understood that the various features, aspects, and functionality described in the embodiment are not limited in their applicability to the particular embodiment with which they are described, but instead can be applied, alone or in various combinations to the embodiment of the disclosure.

It is therefore understood that numerous modifications which have not been exemplified can be devised without departing from the scope of the present disclosure. For example, at least one of the constituent components may be modified, added, or eliminated.

### DESCRIPTION OF THE REFERENCE CHARACTERS

1, 2, 3 update target device
10 vehicle
11 external communication device
12 SW update management device
13 SW update information display device
20 OTA server
21 OTA database
22 vehicle state management device
23 external communication device
100 processor
121 rollback control unit
122 server notification unit
123 search result acquisition unit
124 display notification unit
125 user input acquisition unit
131 search result acquisition unit
132 rollback information display unit
133 user input notification unit
200 storage device
221 vehicle information acquisition unit
222 vehicle version search unit
223 vehicle notification unit

What is claimed is:

1. An update management system comprising:
a software update management device for managing update of software of a plurality of update target devices installed in a vehicle; and
a server provided outside the vehicle and being for managing, in time series, a set of update software versions of the plurality of update target devices, as a vehicle version, wherein
when update of software of at least one update target device out of the plurality of update target devices is not able to be performed, information of software versions of the plurality of update target devices at a time point when the update is not able to be performed is transmitted to the server, and when there is a vehicle version that matches a set of the transmitted software versions, the software update management device withholds a process of restoring the software versions of the plurality of update target devices to a state before the update.

2. The update management system according to claim 1, further comprising an update information display device for displaying the vehicle version that matches the set of the transmitted software versions, the update information display device being for instructing whether or not to allow execution of the process, having been withheld, of restoring the software versions of the plurality of update target devices to a state before the update.

3. The update management system according to claim 2, wherein
the software update management device comprises
a rollback controller to control the process of restoring the software versions of the plurality of update target devices to a state before the update,
a server notification circuitry to transmit, to the server, the information of the software versions of the plurality of update target devices at the time point when the update is not able to be performed, and
a search result acquisition circuitry to acquire the vehicle version from the server,
the update information display device comprises
a rollback information display to display the vehicle version acquired from the search result acquisition circuitry, and
a user input notification circuitry to instruct whether or not to allow execution of the process, and
the server comprises
a vehicle version searcher to compare the received information of the software versions of the plurality of update target devices at the time point when the update is not able to be performed, with the update software versions in a vehicle version.

4. An update management method wherein
when update of software of at least one update target device out of a plurality of update target devices installed in a vehicle is not able to be performed, and software versions of the plurality of update target devices at a time point when the update is not able to be performed match one of vehicle versions being a set of update software versions managed in time series, a process of restoring the software versions of the plurality of update target devices to a state before the update is withheld.
